(19) United States
(12) Patent Application Publication
(10) Pub. No.: US 2007/0092652 A1
(43) Pub. Date: Apr. 26, 2007

(54) Screen printing using nanoporous polymeric membranes and conductive inks

(76) Inventors: Matthew P. Timm, Eden Prairie, MN (US); Jonathan DeRocher, Chaska, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/526,859

(22) Filed: Sep. 25, 2006

Related U.S. Application Data
(60) Provisional application No. 60/720,018, filed on Sep. 23, 2005.

(51) Int. Cl. B05C 1/00; B05D 3/12

(52) U.S. Cl. 427/307; 427/558; 427/355; 427/58; 427/468; 118/504; 118/325; 118/213

(57) ABSTRACT

Screen printing methods, processes, apparatuses, and techniques using nanoporous polymeric membranes, and electrical components, such as traces, transistors, circuits, assemblies, and the like additively printed utilizing nanoporous membranes. In one embodiment, the invention includes creating a nanoporous membrane through a chemical process. The membrane is patterned and pores are etched according to a desired pattern. The membrane may then be used to pattern conductive traces on a substrate according to a screen printing or other suitable printing technique.

### RELATED APPLICATION

This application claims the benefit of U.S. Provisional Application No. 60/720,018, filed Sep. 23, 2005, which is incorporated herein by reference in its entirety.

### FIELD OF INVENTION

The invention relates generally to screen printing. More particularly, the invention relates to screen printing using nanoporous polymeric membranes and conductive inks to additively create electrical and other components.

### BACKGROUND OF INVENTION

Screen printing is commonly known in the printing industry as a means for transferring inks onto a substrate. Screen printing is used in many different applications in printing such as, for example, printing of T-shirts, greeting cards, and other printing applications involving an ink transfer. Screens used in screen printing today are typically constructed of a fine nylon mesh having openings that can range from as large as about 200 microns or more to as fine as about 25 microns in diameter, stretched over an aluminum or wooden frame. The screens can be image patterned according to a variety of processes, for example by positive or negative imaging mask techniques using photo-sensitive emulsions.

One current application of screen printing involves printing with conductive inks. Conductive inks have pigments comprising a conductive material, such as, for example, silver or copper. Conductive inks may therefore be used in screen printing processes to create conductive traces or wires on substrates that can be used for interconnects, switches, antennas, and other electrical components.

For example, U.S. Pat. No. 6,471,805, entitled, “Method of Forming Metal Contact Pads on a Metal Support Substrate,” to Thaler et al., discloses a method of forming a patterned layer of metal, such as gold or silver, on a metal support board used to connect to circuits on a ceramic board. The patterned metal is formed by either electroplating or screen printing. U.S. Pat. No. 4,301,189, entitled, “Method for Applying a Solder Resist Ink to a Printed Wiring Board,” to Arai et al., discloses the use of screen printing to apply the solder resist ink. The disclosure discusses mesh screens used in the screen printing process, including screens made of stainless wire, polyethylene fiber silk, and natural or synthetic fiber yarn. U.S. Patent Application Publication No. 2004/0087128, entitled, “Method and Materials for Printing Particle-enhanced Electrical Contacts,” to Neuhaus et al., discloses materials and processes for creating particle-enhanced bumps on electrical contact surfaces through stencil or screen printing processes. Japanese Patent No. 0505805, entitled, “Production of Screen for Screen Printing,” to Hiroshi, discloses a process of chemically etching a metal screen to produce a pattern for screen printing conductive ink lines of width 50 microns or less.

More recently, additive printing processes and techniques have been used in the manufacture of electrical traces, circuits, and other components and assemblies. These electrical components may include complex interconnects with very small, i.e., narrow, individual electrical traces and may include the formation of specific elements, such as printed transistors, where the desired width of source and gate lines is less than 25 microns. Additional electrical components and interconnects with required trace dimensions less than 200 microns in width, and in some applications even narrower, are also being explored. By using printing presses and other similar manufacturing equipment, such electrical components may be manufactured at a lower cost and faster rate than those created according to traditional electronics manufacturing.

Many printing methodologies, processes, and techniques are being explored as suitable for the printing of advanced electrical components and assemblies, including lithography, ink-jet, intaglio, and other additive printing techniques. Screen printing, however, is typically not an option for the printing of electrical components because of current screen technology, wherein screens have relatively large pore sizes, i.e., greater than one micron in diameter. Further, conductive inks typically comprise relatively large conductive particles of silver, copper, and other materials, again on the order of one micron in diameter or greater, which may be compatible with screen pore sizes but do not provide the desired fine-scale printed results. The use of current screens in high resolution applications therefore produces electrical traces and components with non-uniform edges and undesirable varying widths because the individual pore sizes of the screen constitute a significant portion of the desired electrical trace being printed.

Accordingly, today's screen printing technologies cannot attain the high resolution needed in applications in which where extremely small dimension traces must be printed. Therefore, a need remains for screen printing techniques and processes capable of high resolution printing to additively print electrical and other components.

### SUMMARY OF THE INVENTION

According to embodiments of the present invention, a dramatic reduction in pore size of screens and conductive particles in inks improves and broadens applications for printing with conductive and other inks with high resolution. Such applications include the additive printing of electrical components such as, for example, conductive, semiconductive, and dielectric traces. In various embodiments, the electrical components can include circuits, transistors, antennae, and the like.

Therefore, the present invention resolves many of the above-described deficiencies and drawbacks inherent to current screen printing techniques and substantially addresses the aforementioned needs. In particular, various embodiments of the present invention are directed to screen printing methods, processes, apparatuses, and techniques using nanoporous polymeric membranes. The nanoporous polymeric membranes can be used with conductive inks to create electrical circuits, components, and assemblies additively printed according to and utilizing these methods, processes, apparatuses, and techniques.

### BRIEF DESCRIPTION OF THE DRAWINGS

FIG. 1 is a perspective diagram of a nanoporous membrane according to one embodiment of the invention.

FIG. 2 is a block diagram according to one embodiment of the invention.

FIG. 3 is a perspective diagram of a nanoporous membrane according to one embodiment of the invention.

FIG. 4 is a block diagram according to one embodiment of the invention.

FIG. 5 is a block diagram according to one embodiment of the invention.

### DETAILED DESCRIPTION OF INVENTION

Electrical components manufactured by additive printing processes require high resolution printing techniques. High resolution printed images and articles are often difficult to achieve with commercial printing techniques, such as screen printing. The novel combination of nanoporous polymeric membrane technology with conductive inks having small particle size results in the ability to screen print electrical components with adequate resolution. The invention thereby enables screen printing with resolutions of less than about 200 microns, preferably about 25 microns or less, in various embodiments.

In one embodiment, the method of the invention includes creating a porous membrane through a chemical process. The membrane is then patterned and pores are etched according to a desired pattern. The membrane may then be used to pattern conductive traces on a substrate according to a screen printing or other suitable printing technique.

New materials are emerging, driven by nanotechnology initiatives. These new materials include polymeric films and self-assembled block copolymer films, wherein an etchable block is etched from a first block to form a continuous matrix. These nanoporous structures form suitable screens for screen printing objects with a characteristic dimension in a range of less than about 0.1 microns to about 200 microns, preferably less than about one micron to about 100 microns, for example about 25 microns, in one embodiment. In addition, advances in conductive inks have reduced particle sizes of conductive inks to less than about one micron.

There are many different approaches that may yield a nanoporous structure suitable as a screen for printing electrical structures and components. Examples of materials that may be used include self-assembled diblock copolymers such as poly(styrene-b-lactide) (“PS-PLA”) or poly(styrene-b-methyl methacrylate) (“PS-PMMA”) and templated silica or carbon.

A first example of a nanoporous mask is PS-PLA. PS-PLA is a copolymer that can be synthesized using anionic polymerization of styrene followed by formation of a macroinitiator and polymerization of lactide. In Zalusky et. al., “Mesoporous Polystyrene Monoliths,” J. Am. Chem. Soc., 123, 1519-1520 (2001), which is incorporated herein by reference, the following is described: Sec-butyllithium was used to initiate styrene polymerization, followed by ethylene oxide to terminate the polymerization, and the resulting hydroxyl-terminated polystyrene was precipitated and then mixed with triethlyaluminum to form an aluminum alkoxide macroinitiator. This active site was used to polymerize lactide, and the reaction was terminated with acidic methanol. The resulting diblock copolymer was precipitated and dried. Cylindrical morphology was observed in samples with volume fractions ranging from 0.21 to 0.43 and polydispersity indexes were generally 1.1 or less.

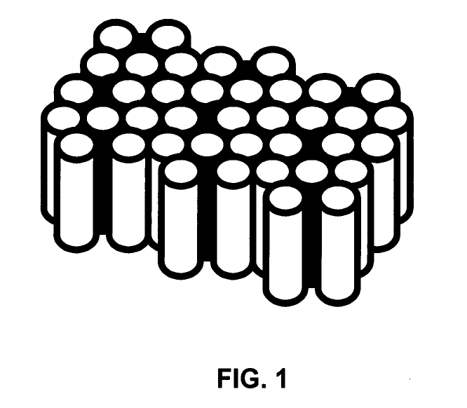

For volume fractions of about 0.2 to about 0.4, a preferred structure has hexagonally packed cylinders of the minority block in a continuous matrix of the majority block, as described by Bates et al. in “Block Copolymers—Designer Soft Materials,” Phys. Today, 52(2), 32-38 (1999), which is incorporated herein by reference. The size of the pores achieved is generally on the order of about 20 nanometers (nm) presently but is adjustable. By changing the length of the blocks while preserving the volume fraction, the pore size can be tuned to a desired value over a wide range. Larger pores can be constructed by blending the copolymer with appropriate amounts of its constituent homopolymers. Also refer, for example, to FIG. 1 of the present application, which includes a simplified representation of hexagonally packed cylinders.

The synthesized material contains cylindrical microdomains but lacks long-range order. Application of shear, e.g., extrusion, pressing, or reciprocating shear, application of an electric field, substrate modification, solvent evaporation, and thermal processing have all been shown to induce alignment of these block copolymers. Refer, for example, to Olayo-Valles et al., “Large area nanolithographic templates by selective etching of chemically stained block copolymer thin films,” J. Mat. Chem., 14(18), 2729-2731 (2004) (hereinafter “Olayo-Valles”), which is incorporated herein by reference.

One factor in making these films porous is using a dual block continuous matrix, wherein an etchable block is selectively etched out of a first block. The methods for such etching vary depending on the chemistry of the block copolymer employed.

In the case of PS-PLA, the ease with which PLA, a biodegradable polymer, can be degraded is advantageous. The PLA can be completely etched using a relatively mild basic solution of methanol and water at room temperature in a relatively short amount of time. This solution does not affect the PS matrix, and therefore the result is a nanoporous polystyrene material. In some studies, this copolymer showed difficulties in forming pores that traverse the entire film when thermal treatment was used for alignment. Refer, for example, to Olayo-Valles. Shear has been shown to produce intact pores and other methods mentioned above may also circumvent this problem.

A second example of a nanoporous mask is PS-PMMA. This copolymer can be synthesized by standard anionic polymerization methods. Thurn-Albrecht et al., “Nanoscopic Templates from Oriented Block Copolymer Films,” Adv. Mater., 12(11), 787-791 (2000), which is incorporated herein by reference. This generally involves initiation by sec-butyllithium. The styrene could be polymerized first and then, without terminating, methyl methacrylate could be added. It could then add to the so-called living chains of polystyrene. Like the PS-PLA, the resulting polymer has a PMMA volume fraction of about 0.3 and a polydispersity index of about 1.1.

For PS-PMMA, selective etching depends on the fact that PS and PMMA have very different chemical responses to ultraviolet (UV) light. PMMA is a negative photoresist and can be etched by UV light and removed with acetic acid. PS, on the other hand, tends to crosslink under UV light, rendering the PS insoluble. This allows for the removal of the PMMA and the formation of a nanoporous material. Extensive studies have shown that electric fields are quite effective in aligning this copolymer. Refer, for example, to Thurn-Albrecht et al., “Overcoming Interfacial Interactions with Electric Fields,” Macromolecules, 33(9), 3250-3253 (2000), and Thurn-Albrecht et al., “Pathways toward Electric Field Induced Alignment of Block Copolymers,” Macromolecules, 35(21), 8106-8110 (2002), which are incorporated herein by reference. More recent studies suggest that solvent evaporation may present an even simpler methodology. See Z. Q. Lin et al., “A Rapid Route to Arrays of Nanostructures in Thin Films,” Adv. Mater., 14(19), 1373-1376 (2002), which is incorporated herein by reference.

Other examples of nanoporous materials include those made from silica or carbon. A silica material can be formed by using amphiphilic triblock copolymers to direct the formation of a porous structure. Refer, for example, to D. Zhao et al., “Triblock Copolymer Syntheses of Mesoporous Silica with Periodic 50 to 300 Angstrom Pores,” Science, 279, 548-552 (1998), which is incorporated herein by reference. Carbon nanoporous films can be synthesized by impregnating the aforementioned silica material with a carbon source, such as a sugar, and carbonizing the sugar before etching away the silica. Refer, for example, to S. Jun et al., “Synthesis of New, Nanoporous Carbon with Hexagonally Ordered Mesostructure,” J. Am. Chem. Soc., 122, 10712-10713 (2000), which is incorporated herein by reference. These materials may be suitable for use with the present application, as they appear to have few defects and reasonably straightforward syntheses. The physical properties, however, are not as favorable as for a polymer mask and the pore sizes, while somewhat tunable, presently have an upper bound of about 30 nm.

In addition to the particular nanoporous materials and membranes described herein, other suitable materials and membranes may also be used, as can be appreciated by those skilled in the art. The material and membrane examples given and described herein are indicative of various embodiments of the invention but in no way limit the suitability of other materials and membranes as contemplated by the present invention.

Nanoporous materials provide advantageous benefits to screen printing according to embodiments of the invention because of the resulting resolution that can be achieved. Screen printing is currently limited by the size of the pores in the screen, rather than the resolution of the patterning that masks the pores. The enhanced resolution of the nanoporous materials comes at a price, however, as it is not typically possible to use traditional conductive inks with nanoporous screens because the conductive particles in the inks are too large to pass through the screen pores. New conductive inks utilizing nanoparticles with diameters of about 50 nm and smaller, though new, are emerging. Using these inks along with enlarged pores of, for example, about 75 nm to about 100 nm, allows the deposit of conductive nanoparticles through the nanoporous mask according to one embodiment of the invention.

Accordingly, and in order to create an “image,” such as an electrical trace, component, structure, or other element using screen printing techniques of preferred embodiments of the present invention, the screen membrane is processed so that ink will only pass through the screen in those areas that require ink to form an image. In non-image areas, the screen will block ink from passing through. In one current screen printing methodology, for example, this is accomplished by exposing a photo negative to light, leaving only non-image areas blocked. Ink is then able to freely pass through the screen and onto the substrate in the image area. Photo positive and other methodologies are also applicable.

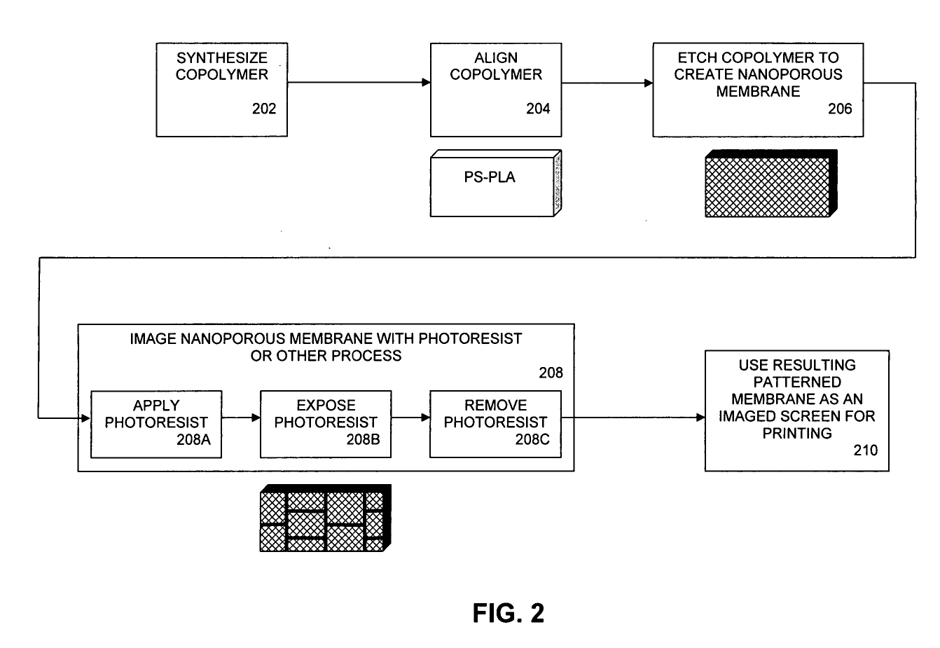

Screens constructed of nanoporous materials are therefore processed so that “image” and “non-image” areas are present. For PS-PLA nanoporous materials as described above, patterning of the mask may be similar to current practices, such as, for example, photo negative or positive imaging. Referring to FIG. 2, a copolymer is first synthesized at step 202 and aligned at step 204. At step 206, the copolymer is etched, for example as described above, to create a nanoporous membrane and then imaged at step 208. In one embodiment, imaging step 208 comprises covering the nanoporous membrane with a photoresist at imaging step 208A, exposing the photoresist at imaging step 208B, and then removing the photoresist at imaging step 208C to develop the image. Imaging processes other than those utilizing photoresist can be used in other embodiments of the invention. The resulting patterned membrane is then used as an imaged screen for printing at step 210.

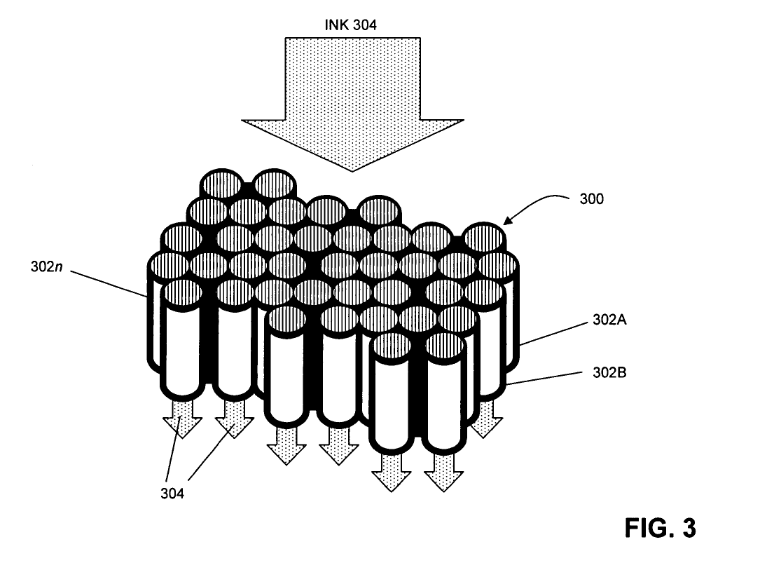

Printing step 210 may include single-layer printing or successive multi-layer printing according to line, rotary, and other screen printing methodologies adapted to conform to registration and resolution goals. For example, an electrical trace screen printed according to the invention can comprise only a single printed layer, while a transistor or other electrical component can comprise multiple successive screen printed layers using differently imaged screens. Referring to FIG. 3, a simplified representation of a nanoporous membrane 300, such as one created according to the process illustrated in FIG. 2, includes a plurality of hexagonally packed cylinders 302A-302n adapted to pass ink 304, such as conductive inks. While somewhat analogous to current screen printing technology, preferred embodiments of the invention nevertheless may provide improved resolutions on the order of at least ten times better than those achieved by current screen printing technologies.

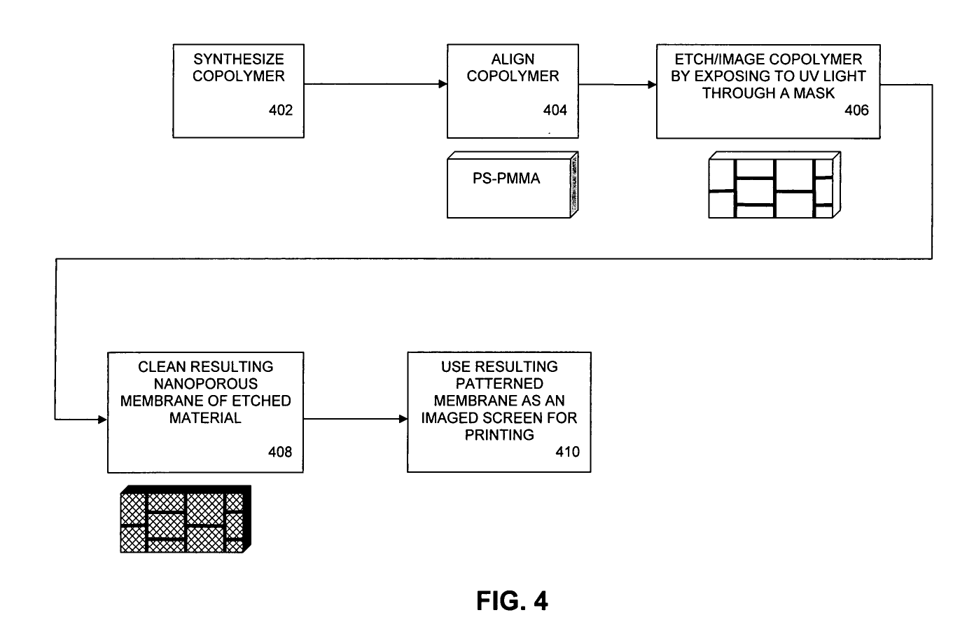

In an alternative embodiment depicted in FIG. 4, another method of patterning the membrane is used. At steps 402 and 404, the copolymer PS-PMMA is synthesized and aligned, respectively. The optical properties of PMMA allow consideration of different patterning schemes. Instead of etching the film before patterning as described above with reference to FIG. 2, PMMA may be patterned directly using UV light at step 406. The PMMA cylinders exposed to UV light may be etched out with a solvent while the unexposed PMMA would remain intact, eliminating the need for photoresist and simplifying production of the screens. The PMMA is cleaned at step 408. In another embodiment, a pattern may be selectively etched using UV light and then patterned with photoresist as described above. Other chemical etching steps and processes may additionally or alternatively be used. The resulting patterned membrane is then used as an imaged screen for printing at step 410. Printing step 410, like step 210 described above, may comprise a single printing stage, or multiple printing stages, using one or more patterned membranes. The patterned membranes may be patterned according to the same process or any combination of different processes.

The physical properties of the nanoporous screens of the invention allow the screens to function in capacities similar to screen printing screens currently used but with improved performance characteristics suited for the demands of additively printing very fine scale electrical components and other structures. Polystyrene, silica, and carbon are all somewhat brittle, but polystyrene is generally better suited than silica or carbon for the membranes of the invention because polystyrene is less brittle than these other materials. Other suitable materials may also be used; block copolymers that use another polymer as the matrix phase, for example polycarbonate, may also provide a tougher, more dependable screen.

The screens may also comprise virtually any size or area compatible with screen printing methodologies and processes. By way of example, a relatively small nanoporous screen, such as one that is about 4 inches by 4 inches as compared to typical screen printing screens used in industry today in other printing applications, may print single layers of about 20,000 individual components or electrical structures on a substrate in a single printing stage at one time. Specialized printing presses and systems can be adapted or manufactured to specifically accommodate the nanoporous screens and printing methodologies of the invention and may include web-fed and other printing systems.

The thickness of the film is also of concern, as a thicker film is more likely to trap the conductive nanoparticles of the ink. Although the pores have been proven to go all the way through the membrane, and although some adjustment can be made related to ink viscosity, a thicker film is more likely to have forking or fusion of pores, tortuous pores, and the like. Block copolymer films having a thickness of about one micron or less have been fabricated but may not be robust enough for various applications.

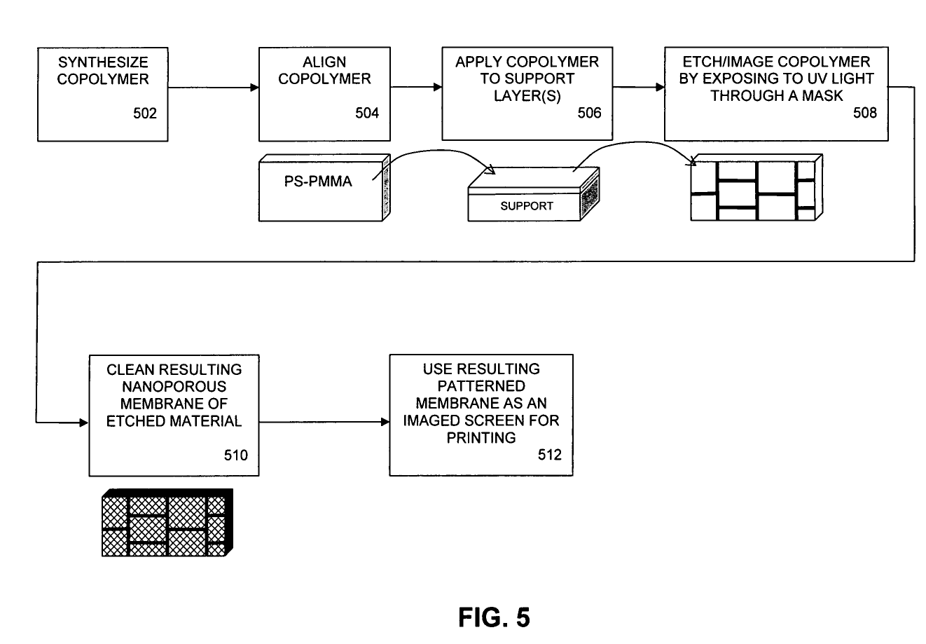

In one embodiment of the invention, therefore, the nanoporous membrane can be deposited on a porous support layer, for example a mask like those used currently or a metal mesh. FIG. 5 is a modified version of the process of FIG. 4, FIG. 4 chosen only for example as FIG. 5 may also comprise a modified version of FIG. 2 or some other suitable process as described herein. Following steps 502 and 504, which are similar to steps 402 and 404 described above, the patterned membrane is applied to a support layer at step 506, with remaining steps 508-512 similar to steps 406-410 as described above with reference to FIG. 4. In other embodiments, the nanoporous membrane may be deposited on the support layer after etching/imaging and cleaning, likely dependent upon the support layer material and other processing factors.

Another issue related to pushing ink through nanoporous masks in screen printing methods according to the present invention is that the drastically reduced diameters of the pores may require a much higher pressure drop across the membrane to force the ink to flow through the membrane. The required pressure drop may be enough to burst the film, especially if no support layer is present. PS-PLA, due to the synthetic scheme by which it is produced, has accessible hydroxyl groups which can be used to perform chemistry on the inside of the pore walls, i.e., the cleavage point between the PS and the removed PLA. Thus, in one embodiment of the invention, the inside of the pores may be coated with molecules to make the pores either hydrophobic or hydrophilic to encourage ink to flow through the membrane. The pores may then be customized and made compatible with a variety of inks being used.

Although it is generally hard to wet pores of this size and may require special solvent combinations, once the pores are wet the solvents can be exchanged and the pores will remain wet. For example, in the case of PS-PLA, water will not wet unmodified pores; a mixture of methanol and water is used instead. One the pores are wet, however, the polymer can be placed in water until the methanol is drawn out and the pores will remain wet. This property along with surface modification may also improve ink flow in embodiments of the invention.

Because screen printing typically requires transferring the ink directly by contact and not by spraying the ink through the pores, surface tension may aid in transferring the ink from the pores to the substrate. Manipulating the chemical composition of the inside of the pores and the substrate could allow ink to move through the pores and onto the substrate without requiring an exorbitant and damaging pressure drop across the screen.

The invention is therefore directed to screen printing methods, processes, apparatuses, and techniques using nanoporous polymeric membranes, and to electrical components, such as traces, transistors, circuits, assemblies, and the like additively printed utilizing nanoporous membranes. Various embodiments of the invention thereby resolve many of the above-described deficiencies and drawbacks inherent to current screen printing techniques and may produce additively printed components having improved qualities and characteristics. The invention may be embodied in other specific forms without departing from the essential attributes thereof; therefore, the illustrated embodiments should be considered in all respects as illustrative and not restrictive.

1. An additive printing system comprising:
a screen comprising a nanoporous polymeric membrane;
a nanoparticle material;
a substrate; and
a screen printing apparatus adapted to selectively deposit the nanoparticle material in a pattern on the substrate by passing the nanoparticle material through the screen.

2. The additive printing system of claim 1, wherein the screen comprises a selectively patterned nanoporous polymeric membrane.

3. The additive printing system of claim 2, wherein the selectively patterned nanoporous polymeric membrane comprises a plurality of pores treated to control hydrophobicity.

4. The additive printing system of claim 1, wherein the screen printing apparatus further comprises a rotary screen printing apparatus.

5. The additive printing system of claim 1, wherein the screen printing apparatus further comprises a flatbed screen printing apparatus.

6. The additive printing system of claim 1, wherein the nanoparticle material is selected from the group consisting of: an electrically conductive material, a semiconductive material, a dielectric material, and a ferroelectric material.

7. The additive printing system of claim 6, wherein the nanoparticle material comprises an ink.

8. The additive printing system of claim 1, wherein the nanoporous polymeric membrane comprises carbon.

9. The additive printing system of claim 1, wherein the nanoporous polymeric membrane comprises silicon.

10. The additive printing system of claim 1, wherein the pattern comprises at least a portion of an electrical component selected from the group consisting of: a line, a trace, a circuit, a circuit element, and a transistor.

11. The additive printing system of claim 1, wherein the substrate comprises a web.

12. A method for depositing material using a nanoporous polymeric membrane comprising the steps of:
aligning a copolymer;
creating a nanoporous polymeric membrane by patterning the copolymer; and
selectively depositing a material on a substrate by passing the material through the nanoporous polymeric membrane.

13. The method of claim 12, wherein the step of creating further comprises:
etching the copolymer to create the nanoporous polymeric membrane; and
imaging the nanoporous membrane.

14. The method of claim 13, wherein the step of etching the copolymer further comprises selectively etching an etchable block of the copolymer from a non-etchable block of the copolymer.

15. The method of claim 13, wherein the step of imaging further comprises:
applying a photoresist;
exposing the photoresist; and
removing the photoresist.

16. The method of claim 12, wherein the step of creating further comprises:
imaging the copolymer by exposing the copolymer to ultraviolet (UV) light through a mask;
etching the copolymer to create the nanoporous polymeric membrane; and
cleaning the nanoporous polymeric membrane.

17. The method of claim 16, wherein the step of imaging further comprises exposing the copolymer to UV light through a mask to create an etchable and a non-etchable area of the copolymer, and wherein the step of etching the copolymer further comprises etching the etchable area of the copolymer.

18. The method of claim 12, wherein the step of selectively depositing a material further comprises:
selecting the material from the group consisting of: an electrically conductive material, a semiconductive material, a dielectric material, and a ferroelectric material; and
selectively depositing the material on a substrate by passing the material through the nanoporous polymeric membrane.

19. The method of claim 12, wherein the step of selectively depositing a material further comprises:
selecting a nanoparticle ink material from the group consisting of: an electrically conductive nanoparticle ink, a semiconductive nanoparticle ink, a dielectric nanoparticle ink, and a ferroelectric nanoparticle ink; and
selectively depositing the nanoparticle ink material on a substrate by passing the nanoparticle ink material through the nanoporous polymeric membrane.

20. The method of claim 12, further comprising the step of selecting at least one self-assembled block copolymer.

21. The method of claim 20, wherein the step of selecting at least one self-assembled block copolymer further comprises selecting at least one self-assembled block copolymer film blended with constituent homopolymers.

22. The method of claim 20, wherein the step of selecting at least one self-assembled block copolymer further comprises selecting at least one self-assembled block copolymer film comprising poly(styrene-b-lactide) (PS-PLA).

23. The method of claim 20, wherein the step of selecting at least one self-assembled block copolymer further comprises selecting at least one self-assembled block copolymer film comprising poly(styrene-b- methyl methacrylate) (PS-PMMA).

24. The method of claim 20, wherein the step of selecting at least one self-assembled block copolymer further comprises selecting at least one self-assembled block copolymer film comprising poly(styrene-b-lactide) (PS-PLA) and poly(styrene-b- methyl methacrylate) (PS-PMMA).

25. The method of claim 12, further comprising the step of synthesizing the copolymer.

26. The method of claim 12, wherein the step of creating further comprises creating a nanoporous polymeric membrane comprising a material selected from the group consisting of: carbon and silicon.

27. The method of claim 12, wherein the step of selectively depositing further comprises using the nanoporous polymeric membrane as a screen in a screen printing apparatus to selectively deposit the material on a substrate.

28. The method of claim 27, wherein the step of using the nanoporous polymeric membrane as a screen in a screen printing apparatus further comprises using the nanoporous polymeric membrane as a screen in rotary screen printing apparatus to selectively deposit the material on a substrate.

29. The method of claim 27, wherein the step of using the nanoporous polymeric membrane as a screen in a screen printing apparatus further comprises using the nanoporous polymeric membrane as a screen in flatbed screen printing apparatus to selectively deposit the material on a substrate.

30. The method of claim 27, wherein the step of using the nanoporous polymeric membrane as a screen in a screen printing apparatus further comprises lithographically patterning the screen.

31. The method of claim 12, further comprising the step of treating pore surfaces of the nanoporous polymeric membrane to encourage material passage through the nanoporous polymeric membrane.

32. The method of claim 12, wherein the step of selectively depositing a material further comprises selectively depositing at least one material to form an electrical component selected from the group consisting of: a line, a trace, a circuit, a circuit element, and a transistor.

33. The method of claim 12, further comprising the step of applying the copolymer to at least one support layer.
